(19) United States
(12) Patent Application Publication
(10) Pub. No.: US 2026/0131741 A1
(43) Pub. Date: May 14, 2026

(54) CONVERTIBLE HITCH PLATFORM AND CARGO CARRIER

(71) Applicant: Ryan Lee Richardson, Greenville, SC (US)

(72) Inventor: Ryan Lee Richardson, Greenville, SC (US)

(21) Appl. No.: 19/384,911

(22) Filed: Nov. 10, 2025

Related U.S. Application Data
(60) Provisional application No. 63/718,190, filed on Nov. 8, 2024.

(51) Int. Cl. B60R 9/06; A47B 3/08; A47B 9/14

(52) U.S. Cl. CPC B60R 9/06; A47B 3/08; A47B 9/14; A47B 2003/0824

(57) ABSTRACT

A convertible cargo carrier includes a frame formed by a first set of side rails extending along a lengthwise direction and a second set of side rails extending along a widthwise direction between the first set, defining a perimeter. A top panel is mounted to the frame at the perimeter and defines a top surface for supporting cargo. The carrier further includes a pair of side panels—each fixed to the first set of side rails—where the first and second side panels respectively define a first and second opening that are aligned along a common axis. A plurality of legs are pivotally attached to the frame and are movable between a closed position, where the legs are positioned between the top panel and the common axis above the openings, and an open position, where the legs extend below the openings to support the carrier.

### BACKGROUND

A cargo carrier is an external storage solution configured to mount to the rear of a vehicle using a hitch receiver mount. The need for efficient and versatile cargo storage solutions has grown with the increase in outdoor recreational activities such as tailgating, camping, biking, hunting, and fishing. Traditionally, individuals relied on separate cargo carriers and portable tables to meet their storage and functional requirements during these activities. This often led to increased preparation time, additional packing, and the inconvenience of managing multiple pieces of equipment.

Cargo carriers are external storage solutions designed to mount onto the rear of a vehicle using a hitch receiver. They typically include a platform to support cargo and a hitch mount for attachment to the vehicle. While effective for transporting gear, these carriers can become cumbersome and obstructive when stationary, often requiring removal and storage under the vehicle when not in use at the destination.

To address these challenges, the concept of convertible cargo carriers emerged, combining the functionality of cargo carriers with additional features such as foldable tables. This innovation aims to enhance user convenience by eliminating the need for separate equipment, thereby streamlining packing and setup processes for outdoor activities.

### BRIEF DESCRIPTION

A table-cargo carrier is disclosed. The table-cargo carrier pertains to a versatile cargo carrier that can be converted into a table, providing dual functionality for outdoor enthusiasts. The cargo carrier connects to a vehicle's trailer hitch receiver using a square tubing, such as a standard 2″×2″ square tubing, ensuring compatibility with most vehicles. The carrier includes a platform for supporting cargo, and when not in transit, the platform can be easily transformed into a table with adjustable legs.

The cargo carrier features legs that fold under the platform when in travel mode. The square tubing slides into a square hole beneath one or more legs of a plurality of legs, securing them in place during transit. When stationary, the legs can be extended to convert the carrier into a table. The legs of the table-cargo carrier are telescopic, allowing for height adjustment to accommodate user preferences and to ensure stability on uneven ground. This feature enhances the usability of the table, making it adaptable to various outdoor environments. The square tubing not only serves as the main hitch support but also secures the legs during travel. When used as a table, the removable hitch tubing is configured for removable attachment and thus designed to be removed to avoid obstructing the walking area around the table, providing an unobstructed space for users. A first side of the cargo platform includes a lip or rail to secure cargo during transport. This lip or rail can be removed when the platform is used as a table, allowing for a flat and usable surface area. This adaptability makes the disclosed table-cargo carrier suitable for a wide range of activities and requirements. Additionally, the table-cargo carrier is designed with future accessory integration in mind. Possible accessories include a bike rack, trash bag holder, paper towel holder, anti-wobble mechanisms, and anti-theft locks. These accessories enhance the functionality and security of the table-cargo carrier.

Alternative embodiments include side rails or lips to secure cargo. These can be detached as needed, providing flexibility for different uses. The design includes end slide-out side extensions that can support additional accessories such as cooking burners, trash bag holders, or drop-in sinks. These U-shaped flat bars enhance the versatility of the table surface. A fold-up backboard can be added to the long side of the table-cargo carrier. This backboard folds flat when not in use, providing additional support for cargo during transport and extending the usable surface area when deployed. An accessory canvas cargo belt or sleeve can be attached to the backboard, featuring pouches for organizing cooking utensils, plates, spices, and other items. This organizational feature maximizes surface space and enhances the functionality of the table during tailgating or camping activities.

By integrating these features, the convertible hitch platform and cargo carrier addresses the common issues faced by outdoor enthusiasts, providing a practical, space-saving solution that enhances convenience and usability during various activities.

### FIGURES

FIG. 1 illustrates a perspective view of a table cargo carrier;

FIG. 2 illustrates the perspective view of the table cargo carrier with legs in the open position;

FIG. 3 illustrates a view of the legs depicted in FIG. 2;

FIG. 4 illustrates a removable rack assembly;

FIG. 5 illustrates a bottom-up view of the frame assembly; and

### DETAILED DESCRIPTION

The present cargo carrier pertains to a multifunctional table-cargo carrier that transitions from a cargo transport to a convenient table, catering to the needs of outdoor enthusiasts. It attaches to a vehicle's trailer hitch using standard square tubing, ensuring compatibility with most vehicles. The cargo carrier's platform is designed for secure cargo transport and transforms into a table with adjustable telescopic legs for stability. Removable side rails provide flexibility, allowing for a flat table surface when needed. The design also supports future accessory integration, enhancing its versatility and functionality for various outdoor activities.

The cargo carrier is designed to attach to a vehicle's trailer hitch receiver using a square tubing, such as a standard 2″×2″ square tubing. The cargo carrier includes a platform that serves as the base for transporting cargo and can be transformed into a table when stationary. The table-cargo carrier may include a plurality of legs that are telescopic and foldable, allowing for easy adjustment and storage. The square tubing, which serves as the main hitch support, slides into a square hole beneath the legs, securing them in place during transit. When used as a table, the tubing can be removed to avoid obstructing the walking area around the table.

A first side of the cargo platform is designed with a rack option that secures cargo during transport and can be detached to provide a flat table surface. The telescopic legs can be adjusted to accommodate various heights, ensuring stability on uneven ground. The design also allows for future accessory integration, with potential accessories including a bike rack, trash bag holder, paper towel holder, anti-wobble mechanisms, and anti-theft locks.

The frame of the table-cargo carrier is constructed from durable materials such as steel or aluminum, ensuring both strength and lightweight properties. The legs are designed to fold under the frame when not in use, with a locking mechanism to secure them in place during transit. This design ensures that the carrier remains compact and easy to handle when not deployed as a table.

In one embodiment, the frame includes a rack option with removable cross pipes to secure cargo. These cross pipes are designed to be easily removed, providing flexibility for different uses of the table surface. The frame also incorporates end slide-out side extensions that can support additional accessories such as cooking burners, trash bag holders, or drop-in sinks. These extensions are made of U-shaped flat bars that slide out from the ends of the frame, providing extra surface area and functionality.

A fold-up backboard can be added to the long side of the table-cargo carrier. This backboard folds flat against the frame when not in use, providing additional support for cargo during transport and extending the usable surface area when deployed. The backboard is designed to be easily folded and locked into place, ensuring stability and convenience.

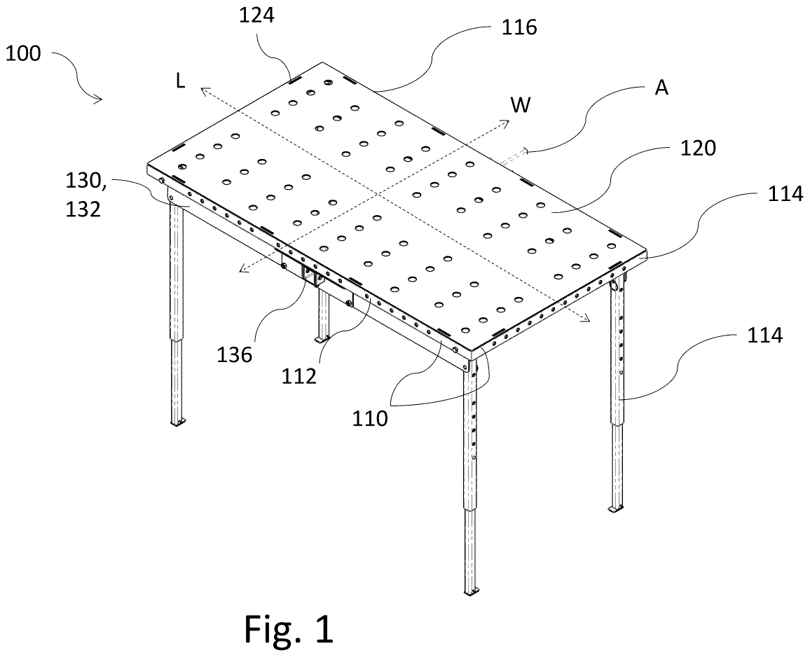

Turning to the figures, FIG. 1 illustrates the convertible cargo carrier in its table configuration. FIG. 1 shows the frame of the cargo carrier with its telescopic legs extended, converting the carrier into a table. The square tubing that connects to the vehicle's hitch receiver is depicted beneath the frame, demonstrating its removable nature when the carrier is in use as a table. The folding mechanism of the legs, as shown, ensures that they are securely locked in place to provide stability.

As shown in the perspective view of FIG. 1, the disclosed technology comprises a convertible cargo carrier 100. FIG. 1 is a perspective view of a convertible cargo carrier assembly 100. The assembly includes a frame defined by a first set of side rails 112 that extend along a longitudinal or lengthwise direction and a second set of side rails 114 that extend along a widthwise direction and connect the first set of side rails, defining a frame. These rails define the outer perimeter of the frame. A top panel 120 is mounted to the upper perimeter of the frame and provides a surface configured to support cargo. On opposing longitudinal sides of the carrier, a first side panel 130, 132 and a second side panel are affixed to the first set of side rails 112. Each side panel defines an opening, with opening 136 defined by the first side panel and opening 138 defined by the second side panel. These openings are aligned along a common axis A, and are configured to receive a hitch tubing in certain configurations, such as during transit. Also shown is a plurality of legs 136, which are pivotally attached to the underside of the frame and disposed between the top panel and the aligned openings in the side panels. The legs are shown in a stowed or closed position in which they are blocked by the hitch tubing and do not extend below the frame. The frame also includes a series of attachment slots 134 located along the perimeter, formed by the alignment of panel openings in the top panel with corresponding rail slots in the side rails. These slots allow for modular mounting of accessory components such as racks.

The cargo carrier 100 includes a frame designed to provide stability and functionality. In some embodiments, the frame may be composed of multiple interconnected panels including an elongated first panel and an elongated second panel. These elongated panels are integral to the structural integrity of the cargo carrier and are designed to interface seamlessly with additional components. The elongated first panel and the elongated second panel are connected the main frame to provide lateral support. The main frame comprises two length rails and two width rails align with the length rails at corners ensuring a secure and stable connection. The corners ### may form ninety-degree angles. Additionally, the frame may include a cross support that stretches from the width rails. The two elongated panels may be formed with a square opening to support hitch tubing. The top of the main frame may include a table with a flat surface to support loads during transit. The table includes strategically positioned openings that allow accessories such as a rack option (discussed further below) to slide into place. These openings are engineered to align with corresponding elements on the rack option to ensure a secure and stable connection.

The cargo carrier may include a plurality of legs 136 with each designed to provide support and stability when deployed. The plurality of legs may be pivotally attached to the frame at a designated pivot point. This pivotal connection allows for rotational movement which enables the legs to transition between open and closed positions.

In the embodiment shown in FIG. 1, the plurality of legs 136 may be pivoted in an open position, rather than a closed position discussed in further detail below. This configuration is achieved through a hinge mechanism at the pivot point, which may include a locking feature to secure the legs in place when extended. When the legs 136 are pivoted to the open position, the cargo carrier is transformed into a functional table. This conversion is facilitated by the precise alignment and length of the legs, which are designed to provide a stable and level surface. The legs may include feet pads to accommodate uneven terrain which further enhances the versatility of the cargo carrier.

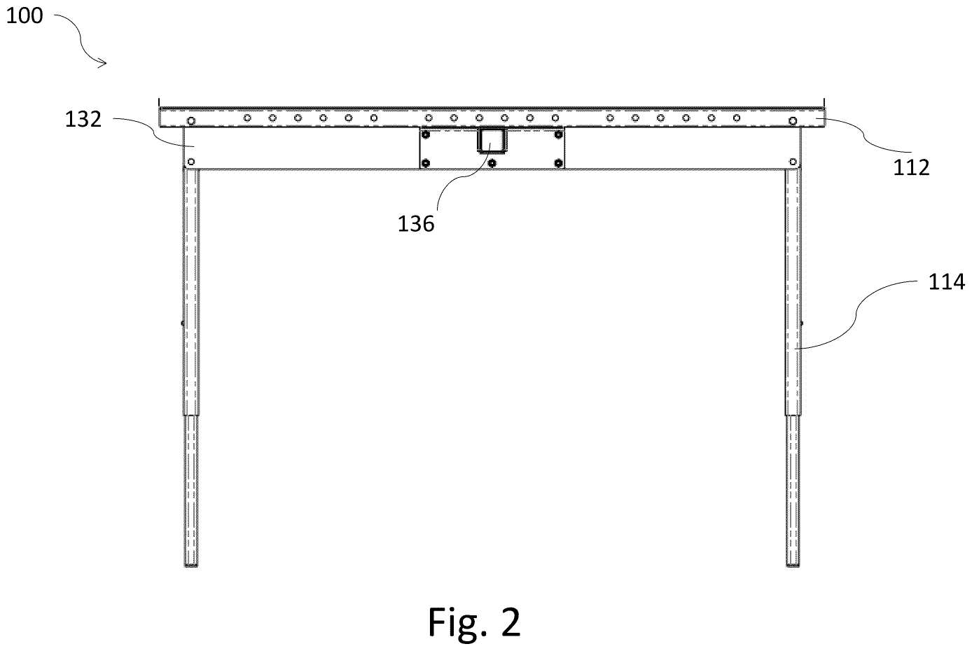

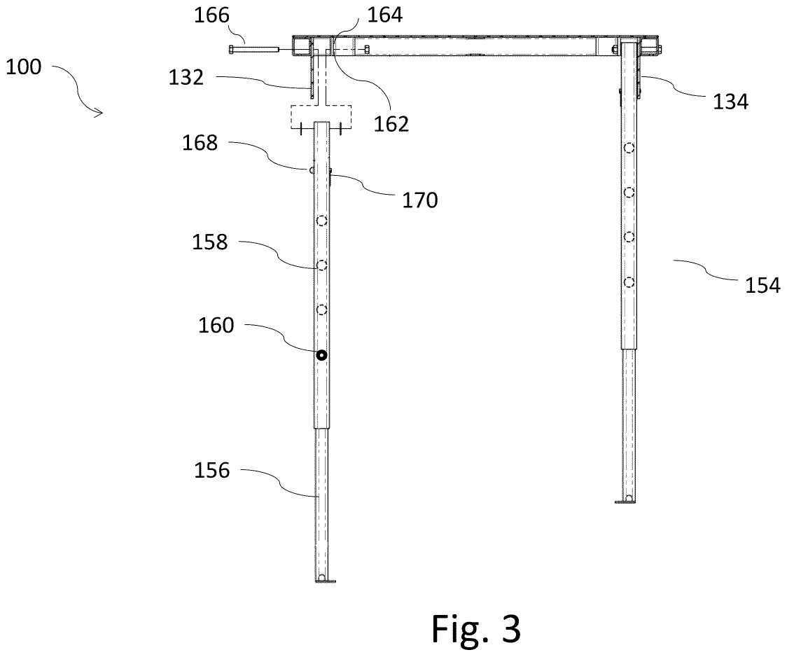

FIG. 2 provides an underside perspective view of the cargo carrier assembly 100 with the legs 136 pivoted into an open or deployed position. Each leg extends downwardly beneath the carrier, providing ground contact for free-standing operation. The legs include telescopic sections 156 (see FIG. 3) with a plurality of locking holes 166 and pin-lock mechanisms 168, allowing the legs to be height-adjustable and secured at various lengths. The legs are pivotally attached to the frame using brackets 158 that include pivot apertures 162. Pivot pins 164 inserted through these apertures define the rotational axes for the legs. When in the open position, the legs rotate downward beyond the aligned openings of the side panels, enabling a standalone support configuration. Also visible is a locking tab 170 formed near the base of each leg, configured to mechanically engage the frame when the leg is fully extended, thereby preventing unintentional upward rotation during use.

In certain embodiments, as shown in FIG. 2, the panel opening 136 is a square opening. This opening is engineered to extend fully through both panels which provides a direct passage for the insertion of hitch tubing. This design ensures alignment and secure engagement with hitch tubing which facilitates efficient load transfer and stability during towing.

Referring to FIG. 3, a detailed view of telescoping legs 136 is shown in the open position 154. The leg includes an outer tube and a lower inner section 156 that can be adjusted in length and locked in position using a spring-loaded pin 160 that interfaces with one of several locking holes 158. A locking feature 168, 170 is structured to latch against a frame component when the leg is deployed in its fully open position. This mechanism ensures secure ground contact and prevents collapse during loading or stationary use. Moreover, FIG. 3 depicts the plurality of telescopic legs 136 may be pivotally attached to the main frame at a designated pivot point 164, allowing for smooth transition between open and closed positions. The designated pivot point is established by a bracket 162 that permits pivotal movement of the leg between a folded position and an extended position. The bracket may be secured with a pin 166 that extends through the frame to form a reliable pivot point. The lower end of the plurality of legs 156 is capable of vertical movement, allowing them to be securely positioned within a series of openings 158. These openings are strategically spaced along the leg to enable customizable height settings.

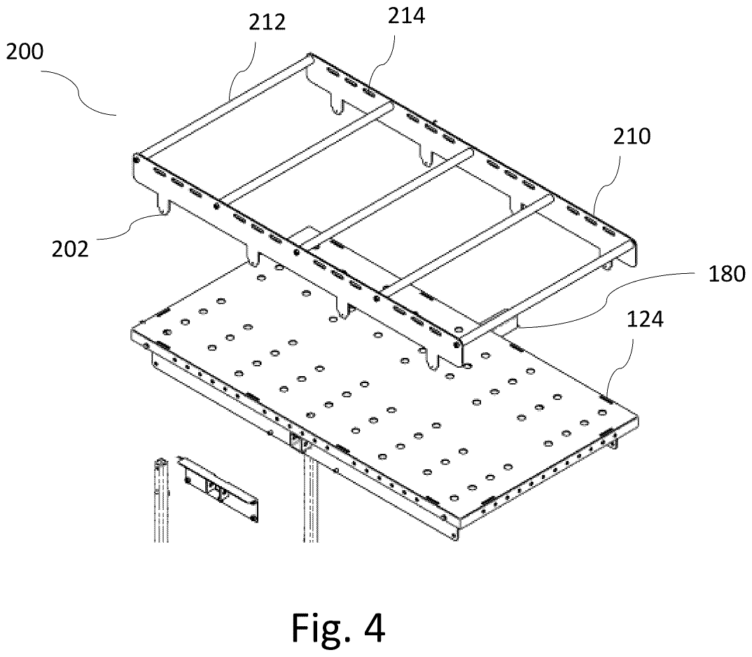

FIG. 4 illustrates a removable rack assembly 200 that serves as an attachment accessory for the cargo carrier. The rack includes a pair of opposing side walls 212 and 214, each configured with multiple strap-receiving slots 180 along their upper edges. The rack also includes a series of removable crossbars 202 that span the gap between the side walls. At the base of the rack are mounting tabs 210 designed to align with and insert into the attachment slots 134 formed in the top panel and rails of the carrier frame. These mounting tabs allow the rack to be installed or removed without tools, enabling flexible use and modular configuration depending on user needs. In some embodiments, this rack option is equipped with a plurality of cross pipes which extends between opposed sides of the rack option. These cross pipes are engineered for easy removal which allows the carrier to accommodate specific load requirements and enhances versatility. The rack option may further consist of strap receiving features designed to facilitate securement of cargo during transit. The strap receiving features may include slots which are integrally formed directly onto the side of the rack option. Each slot is configured to receive securing elements such as a flexible strap, cord, or rope. The plurality of strap receiving features may be spaced at varied intervals distributed along opposed sides of the rack option to allow for balanced retention of cargo.

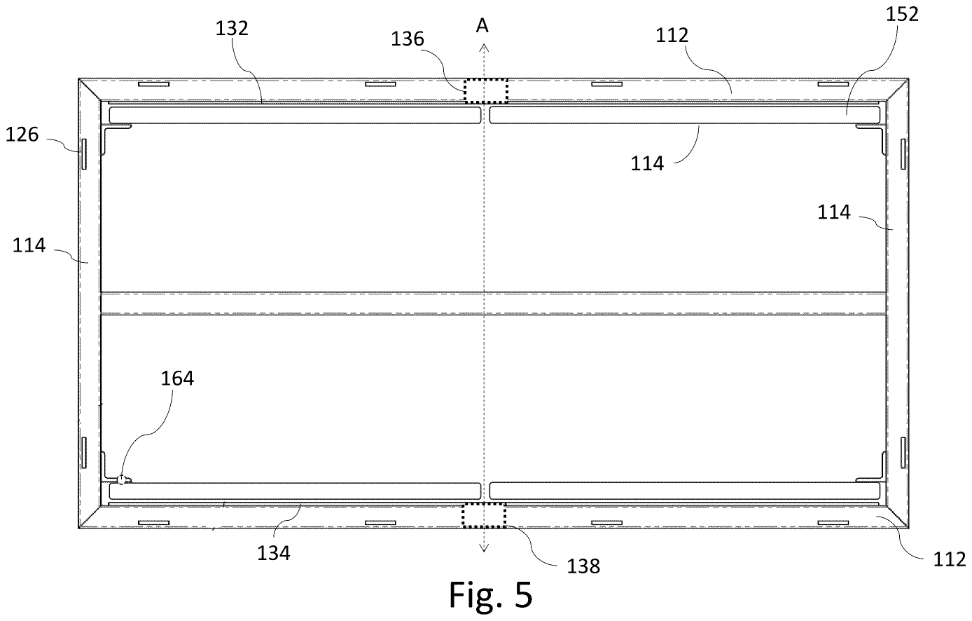

FIG. 5 shows a detailed view of the top assembly of the cargo carrier. side panels 130 and 132, and legs 136. This view highlights how the panel openings 132 align with rail slots 134 to form the attachment slots 138 around the perimeter. It also clearly shows the aligned openings 120 and 124 on the side panels, which form a square passage along common axis A for receiving hitch tubing during transit. The top panel 110 is removed to show the internal structure of the frame and placement of the side panels and leg brackets. The hitch tubing 180 (FIG. 4), when inserted, blocks leg rotation and secures the legs in the closed position during transportation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed:

1. A convertible cargo carrier, comprising:
a frame having a first set of side rails extending along a length direction and a second set of side rails extending along a width direction between the first set of side rails, the first and second sets of side rails defining a perimeter;
a top panel mounted to the frame at the perimeter, the top panel defining a top surface;
a pair of side panels comprising a first side panel and a second side panel, the first side panel defining a first opening and the second side panel defining a second opening, wherein the pair of side panels is fixed to the first set of side rails such that the first and second openings are aligned along a common axis; and
a plurality of legs pivotally attached to the frame, each leg being movable between a closed position in which the leg is disposed between the top panel and the common axis, above the first and second openings, and an open position in which the leg extends below the first and second openings.

2. The cargo carrier of claim 1, wherein each leg comprises a telescopic section having a plurality of locking holes and a pin-lock mechanism configured to secure the leg at an adjustable height.

3. The cargo carrier of claim 1, wherein the first opening and the second opening define a square-shaped opening sized to receive a hitch tubing in a transport configuration.

4. The cargo carrier of claim 3, wherein the hitch tubing is removably inserted through the aligned openings and configured to retain the plurality of legs in the closed position during transit, the plurality of legs being disposed between the hitch tubing and the top panel.

5. The cargo carrier of claim 1, further comprising a plurality of attachment slots, each attachment slot defined by a panel opening in the top panel aligned with a corresponding rail slot in the frame perimeter.

6. The cargo carrier of claim 5, further comprising a removable rack assembly having a plurality of mounting tabs configured to engage the plurality of attachment slots.

7. The cargo carrier of claim 6, wherein the rack assembly comprises a pair of side walls, a plurality of removable crossbars, and a plurality of strap-receiving slots disposed on at least one of the side walls.

8. The cargo carrier of claim 1, further comprising at least one slide-out extension disposed at an end of the frame and supported by the pair of side panels.

9. The cargo carrier of claim 1, further comprising a pull-tab mechanism configured to retain each leg in the closed position, wherein disengagement of the pull-tab mechanism releases the leg for movement toward the open position.

10. The cargo carrier of claim 1, wherein each leg is pivotally attached to the frame via a bracket secured to the frame, the bracket defining a pivot aperture configured to receive a pivot pin that establishes a pivot axis for the leg.

11. The cargo carrier of claim 1, wherein each leg includes a locking feature configured to mechanically engage the frame when the leg is in the open position, the locking feature preventing upward rotation of the leg until manually released.

12. A cargo carrier system, comprising:
a frame comprising a first set of side rails extending along a length direction and a second set of side rails extending between the first set of side rails in a width direction;
a top panel secured to the frame and defining a plurality of panel openings;
a set of rail slots disposed along the first and second set of side rails and aligned with the plurality of panel openings to form a plurality of attachment slots; and
an attachment assembly comprising a rack configured to be removably mounted to the frame, the rack including a plurality of mounting tabs configured to be received within the plurality of attachment slots to secure the rack to the frame without tools.

13. The cargo carrier system of claim 12, wherein the rack comprises a pair of side walls and at least one crossbar extending between the side walls.

14. The cargo carrier system of claim 13, wherein the at least one crossbar is removably secured to the side walls via a locking tab interface.

15. The cargo carrier system of claim 12, wherein the rack further comprises a plurality of strap-receiving slots formed along an upper edge of at least one of the side walls.

16. The cargo carrier system of claim 12, wherein the plurality of attachment slots are uniformly spaced along the perimeter of the frame to accommodate modular placement of the attachment assembly.

17. The cargo carrier system of claim 12, further comprising a pair of side panels comprising a first side panel and a second side panel, the first side panel defining a first opening and the second side panel defining a second opening, wherein the pair of side panels is fixed to the first set of side rails such that the first and second openings are aligned along a common axis.

18. The cargo carrier system of claim 17, further comprising a plurality of legs pivotally attached to the frame, each leg being movable between a closed position in which the leg is disposed between the top panel and the common axis, above the first and second openings, and an open position in which the leg extends below the first and second openings.

19. The cargo carrier system of claim 18, further comprising a hitch tubing removably inserted through the aligned openings and configured to retain the plurality of legs in the closed position during transit, the plurality of legs being disposed between the hitch tubing and the top panel.

20. A convertible cargo carrier assembly, comprising:
a frame comprising a first set of side rails extending along a length direction and a second set of side rails extending along a width direction between the first set of side rails, the first and second sets of side rails defining a perimeter;
a top panel mounted to the frame and defining a top surface configured to support cargo;
a pair of side panels comprising a first side panel and a second side panel, the first side panel defining a first opening and the second side panel defining a second opening, wherein the pair of side panels is fixed to the first set of side rails such that the first and second openings are aligned along a common axis;
a plurality of legs pivotally attached to the frame, each leg being movable between (i) a closed position in which the leg is disposed between the top panel and the common axis, above the first and second openings, and (ii) an open position in which the leg extends below the first and second openings;
a hitch tubing removably inserted through the first and second openings along the common axis, wherein the hitch tubing is configured to retain the plurality of legs in the closed position during transit by blocking rotation of the legs into the open position;
a plurality of attachment slots defined around the perimeter; and
an attachment assembly comprising a rack configured to be removably mounted to the frame, the rack including a plurality of mounting tabs configured to be received within the plurality of attachment slots to secure the rack to the frame.
